(19) United States
(12) Patent Application Publication
(10) Pub. No.: US 2006/0182620 A1
(43) Pub. Date: Aug. 17, 2006

(54) Pallet cap system and method of use

(76) Inventors: Alex Guidroz, Beaumont, TX (US); William Horn, Norcross, GA (US)

Correspondence Address: John Buche;Buche & Associates, P.C., 2nd Floor, 4445 Eastgate Mall Blvd., San Diego, CA, 92121, US

(21) Appl. No.: 11/206,517

(22) Filed: Aug. 19, 2005

Related U.S. Application Data
(60) Provisional application No. 60/647,891, filed on Jan. 28, 2005.

(51) Int. Cl. B66F 9/18

(52) U.S. Cl. 414/814

(57) ABSTRACT

A pallet transport system that has a pallet cap with raised nodules on a top surface in preferable shapes of squares, circles and other polygons, such nodules providing a surface for cargo to rest on as well as a lattice of channels adapted to receive forked dollies whose tines insert beneath the pallet cargo. The pallet cap is preferably adapted to operate as part of a system, which preferably includes the pallet cap, forked dolly, and a stabilized pallet jack.

### CROSS-REFERENCE TO RELATED APPLICATIONS

This utility application claims the benefit of Provisional Application No. 60/647,891, filed on Jan. 28, 2005.

### STATEMENT REGARDING FEDERALLY SPONSORED RESEARCH OR DEVELOPMENT

Not applicable.

### BACKGROUND OF THE INVENTION

1. Field of Invention

The present invention relates to the field of material handling and systems and apparatus for handling pallet loads.

2. Description of Prior Art

In the material handling industry, and particularly in the industry of beverage distribution, it is desirable to be able to move the greatest number of cases of beverages in the least amount of time, and with the greatest safety and efficiency possible. The general choreography of beverage distribution requires movement of cased products from a warehouse where they are packaged, to trucks, and then to the end retailers of those products, for instance, convenience or grocery stores. Between the warehouse, trucks and the end retailers, cases of product are typically stacked on industry standard pallets, which pallets are either moved by forklifts, pallet jacks, dollies, or human lifting. The latter category of human lifting is the least desirable because of inefficiency and safety concerns. Nevertheless, standard protocol in the beverage distribution industry still involves a great deal of human lifting and inefficiency because of the standard configurations used in product shipping. Presently, the standard in beverage handling requires that cases of beverages be stacked on industry standard pallets, typically made of wood or molded plastic, with such cases positioned in an interlocking fashion. Typically, the cases are stacked so that from layer to layer on the pallet cases the edges of each case are staggered. The cases are stacked so the edges any one case will not line up exactly with the edge of another case on an underlying layer. The stacking continues in this fashion until it reaches a typical height in the range of 3 and 10 feet. This interlocking configuration of cases has proven very sturdy for transport and in storage, but it has a significant drawback. The drawback is that stacking and unstacking of cases packed in this fashion is physically demanding, time consuming, and literally a case-by-case endeavor. The interlocking stacking prevents personnel from using a handtruck or dolly to simultaneously remove multiple cases or columns of product from the pallet. This drawback is significant because it translates to lost time at the site of delivery, particularly where the delivery personnel are required to unload cases one at a time from the pallets in a truck, on to a dolly, and then to cart the cases into the retailer. This drawback should not be underestimated, particularly in instances where a single delivery person is on a truck. The extra time loading and unloading heavy cases, which typically weigh 10-30 pounds each, not only slows delivery schedules, but may also increase potential for injury or strain to workers. The inventors wish to reduce any such complications. Furthermore, the extra time required to move cases one-by-one presents an undesirable situation where trucks and property could be left unattended, thus creating a situation for opportunist theft.

Others in the material handling industry have attempted to improve on the designs of shipping pallets, however, none have done so in the manner of the present invention or by employing methods that achieve the superior results that are needed in the beverage distribution industry. For instance, a patent that issued to Royston Shepherd, U.S. Pat. No. 4,972,782 (1990), disclosed a pallet design featuring channels on a top surface of the pallet in which forks of a forklift could insert to retrieve the load without the pallet. However, this design is not suitable for solving the problems of the present invention, namely, because the raised surfaces and corresponding channels of the pallet top are too large and too few to suit cargo such as cases of beverages or the dollies necessary to retrieve columns of cases. In beverage handling, a dolly must be able to roll over the surface of the pallet so as to permit retrieval of additional columns of product. Other design patents have issued respecting pallets, generally, such as Weber D373,889 (1996); Elder D433,208 (2000); Wheaton D441,516 (2001)); and Nordstrom D263,389 (1982), however all of the ornamental designs featured fail to adequately address the problems solved by the present invention. Each of the referenced patents offer an ornamental feature materially different in configuration from the present invention. The designs fail to provide suitable access to cargo, and have unsuitable surface area and traction for transporting the cargo contemplated by this invention.

### SUMMARY OF THE INVENTION

Accordingly, it is an objective of the present invention to provide a novel pallet cap, related system components and methods of using a pallet cap system that will significantly improve upon existing industry technology and practices. The pallet cap of the present invention is preferably a molded plastic form adapted to fit over industry standard loading pallets, with the pallet cap having raised nodules on a top surface in preferable shapes of squares, circles and other polygons. These raised nodules provide a surface for cargo to rest on as well as a lattice of channels adapted to receive forked dollies whose tines or “forks” insert beneath the pallet cargo. The forked dollies, when used with the pallet cap, permit the user to remove entire columns of beverage cases, instead of one case at a time. The novel pallet cap is adapted to operate preferably as part of a pallet cap system, which system may include the pallet cap, the forked dolly, and a stabilized pallet jack modification described herein.

It is a further objective of the present invention to significantly lessen the time and human lifting required in the transport of cases of product between the warehouse and end destinations.

It is an objective of the present invention to minimize any likelihood of injury on the job that may be occasioned by unnecessary lifting of cases of beverages.

It is an objective of the present invention to provide a novel pallet cap that will fit on top of commercially available pallets, including wooden and plastic pallets.

It is an objective of the present invention to provide a pallet cap with a plurality of raised nodules with enough surface and traction to sustain heavy cargo, for instance, multiple cases of beverages.

It is a further objective of the present invention to provide a pallet cap with raised nodules with enough surface area on which to permit easy movement by the wheels of a dolly.

It is an objective of the present invention to provide a pallet cap with raised nodules and corresponding channels formed between the nodules.

It is an objective of the present invention to provide a pallet cap featuring raised nodules shaped in a manner that will facilitate removal of the cargo on top of the pallet by permitting easy access of a forked dolly beneath the cargo to be transported.

It is a further objective of the present invention to provide a pallet cap that will be stackable on other pallet caps for storage purposes.

It is an objective of the present invention to provide an alternative embodiment of the invention where the actual pallet incorporates the nodules of the pallet cap disclosed.

It is further an objective of the present invention to provide a novel dolly, with a forked base plate, wherein the tines or “forks” of the dolly are adapted to slide in the channels formed by the raised nodules of the pallet cap and beneath the cargo.

It is a further objective of the present invention to provide a novel method of loading cargo on the pallet, wherein cases of beverage are stacked in straight vertical columns as opposed to the industry standard of interlocking case placement, the latter standard requiring unloading and loading of cases of product one by one, each by hand.

It is a further objective of the present invention to provide a method of loading and packaging pallets with straight column configuration by and through use of a novel stabilized pallet jack modification.

It is a further objective of the present invention to provide for a stabilized pallet jack modification that permits transport of pallets at an angle.

Other objectives of the invention will become apparent to those skilled in the art once the invention has been shown and described.

### BRIEF DESCRIPTION OF THE DRAWING

The manner in which these objectives and other desirable characteristics can be obtained is explained in the following description and attached drawings in which:

FIG. 1 is a top perspective view of the pallet cap that depicts the unique raised nodules.

FIG. 2 is a side view of the pallet cap demonstrating how the device is adapted to fit over and “cap” industry standard pallets.

FIG. 3 is a side view of the pallet cap depicting the manner in which the pallet caps may stack on to one another for storage.

FIG. 4 is a perspective view of the current industry standard for unloading a pallet holding cases of beverages. It shows the interlocking configuration of cases, which interlocking promotes stability, however, causes inefficiency in loading and unloading, which must be done case by case.

FIG. 5 is a perspective view of a vastly improved method of unloading entire columns of beverage cases from the pallet using the pallet cap, dolly and system of the present invention.

FIG. 6 is a front perspective view of the forked dolly of the present invention, showing the nose plate featuring a plurality of tines or forks.

FIG. 7 is a front perspective view of the forked dolly demonstrating how the forks are adapted to insert into the lattice of channels formed by raised nodules of the pallet cap.

FIG. 8 is a side view of the stabilized pallet jack, and shows how the pallet jack is adapted to raise the entire column stacked load on the pallet and pallet cap at an angle that enhances stability.

FIG. 9 is a cut-away side view of the stabilized pallet jack that demonstrates novel improvements to the pallet jack that permit lifting at an angle.

FIG. 10 is an underside perspective view of the pallet jack showing the interconnection of pallet jack components.

FIG. 11 is a rear cut-away perspective view showing how the hydraulic system of a pallet jack connects to and operates with the components of the present invention.

It is to be noted, however, that the appended drawings illustrate only typical embodiments of this invention and are therefore not to be considered limiting of its scope, for the invention may admit to other equally effective embodiments.

### DETAILED DESCRIPTION OF THE INVENTION

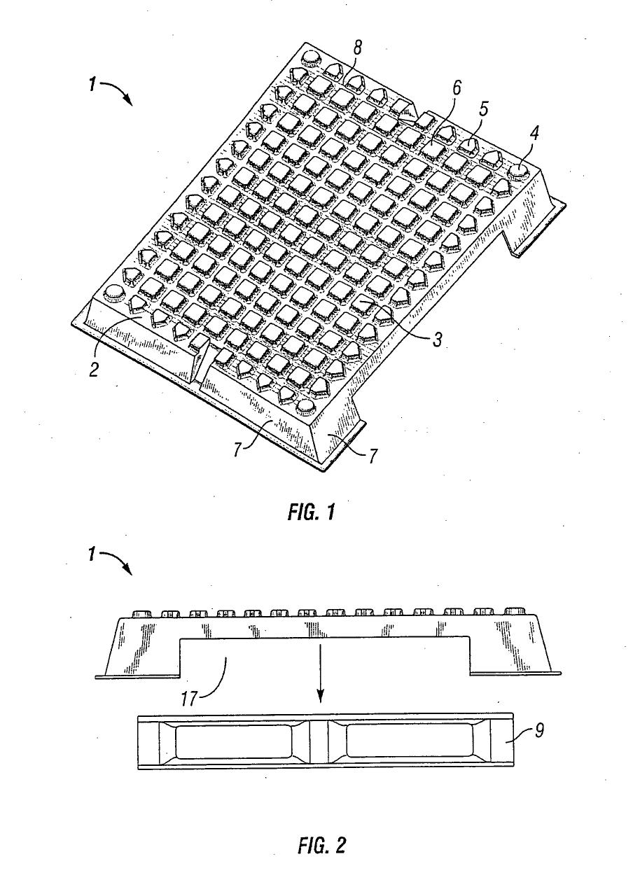

FIG. 1 is a top perspective view of the pallet cap 1 that depicts the unique raised nodules 3 which are an important feature of the invention. A top surface 2 of the pallet features a plurality of said nodules 3, which nodules are raised protuberances spaced to form a lattice of channels 8 occurring between the nodules 3. The channels 8 are adapted to receive the tines 15 of a forked dolly 13 to be discussed further herein. As is showing in FIG. 1, there are a variety of shapes of nodules which are preferable for the top surface 2 of the pallet cap 1, such shapes including a round nodule 4, polygonal nodule 5, and square nodule 6. While various shapes of nodules 3 are contemplated and useful, the round nodules 4 are preferable, but not essential, for the corners of the pallet cap 1 to facilitate guiding the tines 15 of a forked dolly 13 into the channels 8 of the pallet cap 1 with ease. In similar manner, it is preferable to place polygonal nodules 5 along the periphery of the rectangular pallet cap 1. In FIG. 1, it is shown that the polygonal nodules 5 form a shape with a point facing outwards, thus minimizing the likelihood that the tines 15 of a forked dolly 13 will be obstructed as they enter the channels 8 formed between the nodules 3. A square nodule 6 will also function along the periphery of the pallet cap 1, however, the polygonal nodules 5 preferable inasmuch as they tend not to impede and will guide entry of tines 15. The square nodules 6 are shown centrally on the top surface 2 of the pallet cap 1.

The nodules 3 depicted in the pallet 1 are raised protuberances with flat tops and typically of a height above the top surface 2 in the range of ½ to 5 inches. The height is adapted as a function of the space needed to permit a tine 15 of a forked dolly 13 to insert in channels 8 formed between nodules 3 and beneath cargo loaded on top of the nodules 3. The width of channels 8 are also a function of the space needed for easily inserting tines 15 of a forked dolly 13 into said channels 8. The channels are preferably of a width, meaning the space between nodules 3, in the range of ½ to 5 inches. Such preferable dimensions of space between the respective nodules 3 are important in terms of providing not only adequate space for tines 15, but also for ensuring adequate surface area for cargo that rests on top of the nodules 3 of the pallet cap 1. Such spacing of nodules 3 is important for maintaining the integrity of cases of beverages, which are generally cardboard and may sometimes sit for extended periods of time. If the nodules 3 are spaced too far apart, cardboard products, such a beverage cases, will not be adequately supported and may sink, deform, or lack traction during transport. If nodules 3 are spaced too far apart, the wheels of a dolly will also have a difficult time smoothly moving over the pallet cap surface 2. Conversely, if nodules are spaced too close, the cargo will be hard to retrieve because the tines 15 of a dolly will not readily insert into channels 8. Also, the tines 15 of a forked dolly 13 must be broad and strong enough to collectively support a useful load, so channel 8 widths are important from this standpoint. The collective resting surface area provided by the nodules 3 must also be sufficient to resist shifting of the cargo loaded on the pallet cap 1. The surface area of the top of a particular nodule 3 is preferably in the range of ¼ to 36 square inches.

FIG. 1 shows the general features of a pallet cap 1, which is typically rectangular or square in shape given that it is adapted to fit securely over and on top of a standard industry pallet, which is generally made from wood, or frequently pressure molded plastic. The pallet cap 1 is formed from four side surfaces 7 which meet with a top surface 2, with said top surface 2 defining the aforementioned plurality of nodules 3 and corresponding lattice of channels 8. A plurality of side surfaces 7 are fixed to the top surface 2 along a periphery of the top surface 2 with the side surfaces 7 extending downward from the top surface 2. The pallet cap 1 corresponds to fit over industry standard pallets 9, and the rectangular pallet cap 1 of FIG. 1 preferably has a length in the range of 30 to 60 inches; a preferable width in the range of 25 to 50 inches; and a preferable height of the respective sides 7 in the range of 2.5 to 7 inches.

FIG. 2 is a side view of the pallet cap 1 demonstrating how the device is adapted to fit over and “cap” industry standard pallets 9. FIG. 2 further demonstrates how the underside of the pallet cap 1 is hollow and adapted to fit securely and snuggly over the pallet 9. At least two of the four sides 7 feature a jack fork receiving area 17 which provide access to the pallet 9 by the tines of a forklift or pallet jack as is typically used to move an entire pallet of product. The pallet cap 1 is particularly useful because it provides a means for material handlers to make use of existing pallets 9, without having to buy all new pallets featuring the nodules 3 of the present invention. However, it should be noted that the present invention contemplates and hereby discloses a pallet 9 that directly incorporates the nodules 3 defining the top surface 2 of the pallet cap 1. In other words, a preferable embodiment of this invention is a pallet 9 with a top surface of said pallet 9 featuring a plurality of nodules 3 that may be arranged in any manner of combinations as contemplated for use on pallet cap 1. Such an embodiment is further described as a pallet comprising a frame having a top surface and a bottom surface with sides extending therebetween. The top surface 2 of this embodiment also has a plurality of nodules 3 extending upwardly therefrom and a plurality of nodules 3 defining a plurality of channels 8 between the nodules 3. Further, the frame of this embodiment has a fork receiving area 17 formed through at least one of the sides, so that the pallet is suitable for allowing forks of a forklift to pass through to engage the pallet. This application contemplates both a pallet or pallet cap 1 featuring a plurality of nodules 3 extending upwardly from a top surface 2, therefore, systems of the present invention may employ both of such pallet structures.

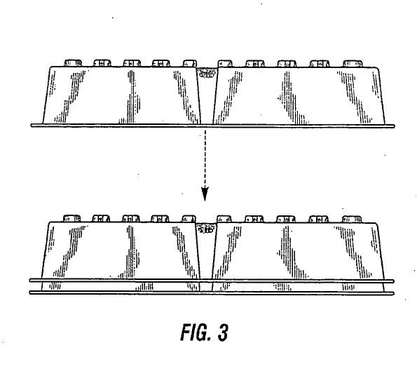

FIG. 3 is a side view of the pallet cap 1 depicting the manner in which the pallet caps 1 may stack on to one another for storage purposes. The side surfaces 7, which extend downward around the periphery of the top surface 2, flare out preferably at an angle. Such an angle, formed at the point where said top surface 2 and side surfaces 7 meet is preferably in the range of 91 to 120 degrees. This slight outward flare of the side surfaces 7 permits pallet caps 1 to rest securely on top of one another. The nodules 3 also are preferable in aide of this stackable feature because the top surface 2 with said nodules 3 and corresponding channels 8 provide a resting surface for the underside of another pallet cap 1. Further, such a because the top surface 2 is not flat, it lessens the likelihood that suction between stacking surfaces will make it difficult to separate the respective pallet caps 1.

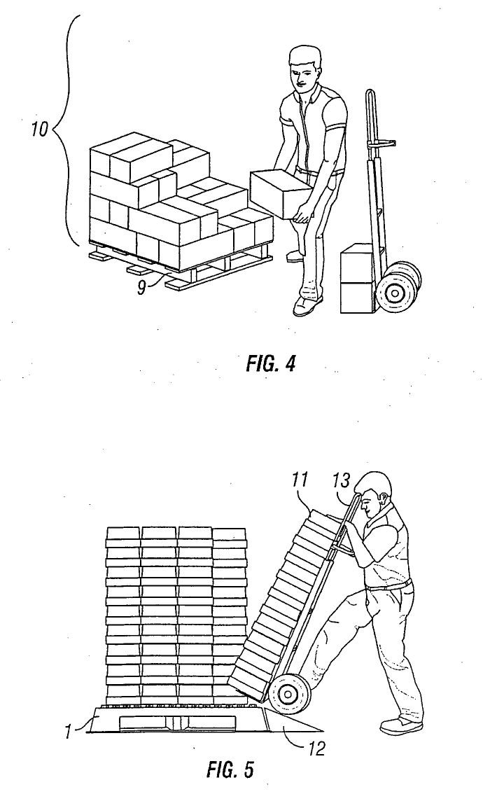

FIG. 4 is a perspective view of the current industry standard for unloading a pallet 9 holding beverage cases 10. It shows the interlocking configuration of cases 10, which interlocking promotes stability, however, causes inefficiency in loading and unloading. While the cases 10 are more securely transported in the initial loading stages at the warehouse, the unloading at the end destination is problematic. The worker is forced to unload the cargo one case at a time and stack the cases on a dolly. This process is time consuming, where time is money, and where deliveries are slowed. The process and the lifting of the task increases a possibility of injury to workers. Additionally important, the excess time that it currently takes to unload a pallet 9 presents greater risk for opportunistic crime while a worker is preoccupied unloading each case to be delivered. The problems depicted in FIG. 4 served as the genesis of the present invention.

FIG. 5 is a perspective view of a vastly improved method of unloading entire columns of beverage cases 10 from the pallet 9 using the pallet cap 1, forked dolly 13 and system of the present invention. A ramp 12 is shown, which is a preferable additional feature helpful in lifting columns 11 of cases resting on the edges of the pallet cap 1. The interlocking stacking depicted in FIG. 4 has been avoided in the present invention.

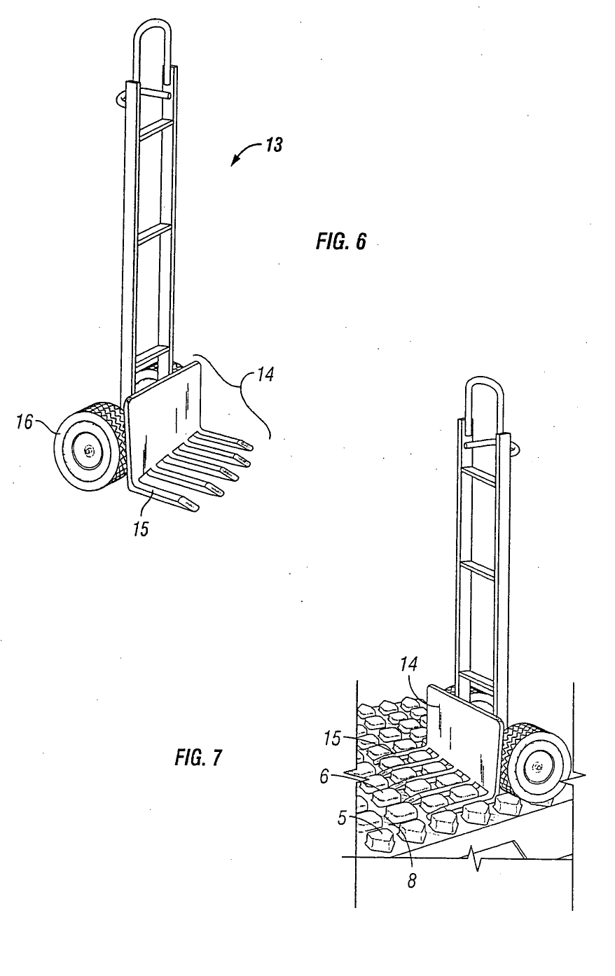

FIG. 6 is a front perspective view of the forked dolly 13 of the system of the present invention, showing the nose plate 14 featuring a plurality of tines 15 which extend from said nose plate 14. Said tines 15 are situated flush with horizontal when the dolly 13 is resting stationary on level ground and in upright position. In other words, the tines 15 preferably extend from and are perpendicular to a vertical portion of said nose plate 14, thus forming an “L” shape when viewed from the side. The tines 15 preferably taper to a point, wherein such shape permits greater ease of guiding the tines 15 into the channels 8 found on a pallet cap 1. Said nose plate 14 is defined by at least two tines 15 extending from the nose plate 14. The nose plate 14 of the present forked dolly 13 is preferably formed from steel or reinforced metal alloy and is securely connected to the base of the dolly where nose plates of commercially available nose plates are typically attached. The dolly has a frame with a base and a handle. Extending upward and connected to the base of the dolly is a dolly handle. The nose plate 14 may be fixed or adapted to be interchangeable or removable with other shaped nose plates, provided that it is adapted to be secure during use. The forked dolly 13 features at least two wheel units 16 rotatably fixed to said base of the dolly frame, as are typically found on dollies generally commercially available, whether pneumatic or of other variety. A narrow wheel base is preferable for use with the pallet cap 1 and the system works best when the bottom of the tire of the wheel unit 16 and the base of the tines 15 rest flush against the ground, or slightly below the ground bottom of the wheels, when the dolly 13 is in upright position. The handle of the dolly 13 and the remaining frame components, including any stair walkers, etc., are those typically found on commercially available carts.

FIG. 7 is a front perspective view of the forked dolly 13 depicting how the tines 15 are adapted to insert into the lattice of channels 8 formed by raised nodules 3 of the pallet cap 1. It should be noted that the forked dolly 13 is designed so that it can rest on top of the pallet cap 1 and rest stable in upright position without assistance. The tines 15 of the nose plate 14 slide easily beneath the cargo. This is a significant improvement over other dollies with flat nose plates that require a user to use his or her hand to tilt the cargo, or cases of beverages, forward to get the nose plate beneath the cargo. In the situation of a pallet 9 full of cases of beverages, it is not possible to tilt the top of the beverages forward because they are blocked by other columns of cases that do not permit easy leaning of the cases 10 to allow the nose plate 14 to get beneath cargo. This feature is particularly useful when trying to load columns 11 of cases 10 that are not resting on the periphery of the pallet 9 (See FIG. 5).

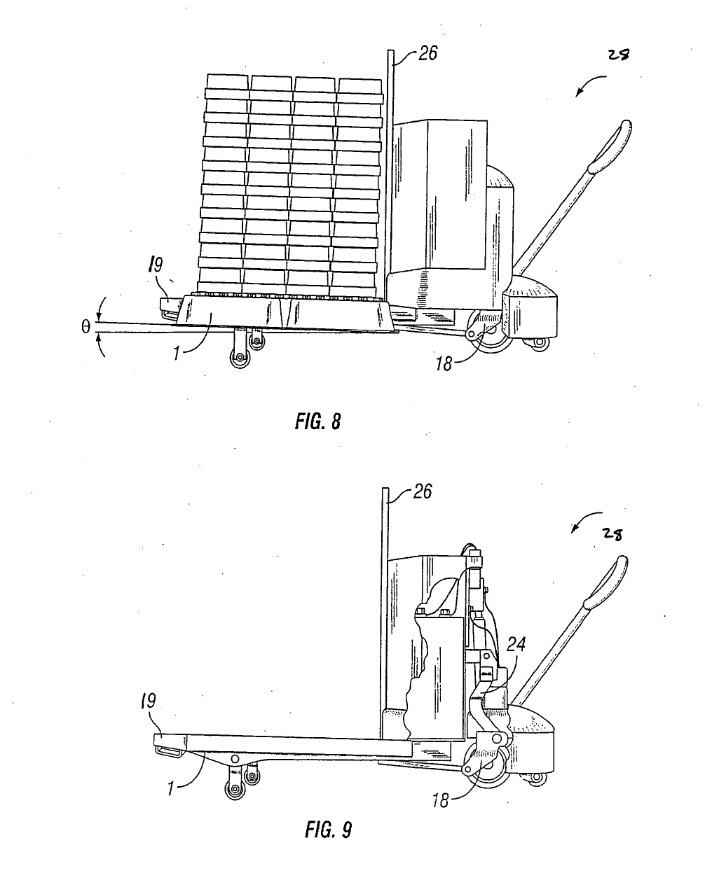

FIG. 8 is a side view of the stabilized pallet jack 28, and shows how the pallet jack 28 is adapted to raise the entire column-stacked load on the pallet 9 and pallet cap 1 at an angle that enhances stability of the cargo. The pallet jack 28 is a beneficial feature in the system of the present invention because it solves a problem of how to transfer a pallet 9 stacked with straight columns 11 of product without causing the cases 10 to fall. The straight column stacking is inherently less stable than an interlocking stacking of cases, therefore, adjustments were made to permit carrying raised loads at an angle in the range of 1 to 30 degrees relative to ground. A pallet tilted at an angle and with cases resting against a backstop 26 fixedly connected to the pallet jack 28 were less likely to be destabilized during transport. The backstop 26 serves a function of supporting the weight of up to a full pallet load of cargo and is preferably of metal construction. This backstop 26 is typically a cage of metal bars, with bars positioned close enough together to prevent cases from slipping through the bars, although a solid backstop 26 can also be used. The most critical time where this improved angled transport is useful is the time immediately after the pallets 1 are loaded in the warehouse, and until the cargo is enveloped with plastic wrap. In the beverage distribution industry, after stacking cases 10 on to a pallet 9, it is typical to use plastic wrap around the stacked cases 10 to secure against side-to-side motion during transport. After a pallet of cases 10 is wrapped, the load is generally stabilized and will transfer with standard pallet jacks, so the present improvement is typically used for transport inside the warehouse, although such transport in other settings is clearly contemplated.

The pallet jack 28 is particularly useful in the system featuring the pallet cap 1 as shown in FIG. 8. A method has been devised of loading cases of beverages, which method involves placing a pallet cap 1 over a pallet 9; loading cases of beverages on top of the pallet cap 1 where the cases are stacked in vertical columns 11; using an improved pallet jack 28 to pick up the loaded pallet 9 (featuring the pallet cap 1); transporting the loaded pallet 9 at an angle in the range of 0 and 30 degrees using the improved pallet jack 28. Additional useful steps and methods might include: transporting the loaded pallet to a location where it may be further stabilized with a stabilizing wrap (e.g., strapping, plastic wrap or their equivalents); thereafter, transporting the stabilized pallet 9 and load to a destination by typical means, for instance by truck, where product is to be delivered. A method of unloading product stacked in vertical columns 11 is also disclosed, whereby after removing stabilizing plastic wraps, ties or their equivalents, a worker uses a dolly to insert underneath and remove entire stacked columns of product simultaneously. As depicted in FIG. 5, use of a pallet cap 1 and forked dolly 13 further enhances the efficiency of this unloading process. A ramp 12 is an optional step that is contemplated as useful, although not necessary.

The pallet jack 28 is useful with the present pallet cap 1 system, however, it should be noted that the pallet jack 28 will carry loads at an angle just as easily without the pallet cap 1. Although the improved pallet jack 28 was designed primarily for use in the beverage industry, the improved pallet jack 28 is beneficial in a variety of industries where angled transport is likely to assist with transportation of awkward or unorthodox cargo configurations.

FIG. 9 is a cut-away side view of the pallet jack 28 that depicts an extender means 18 as it hingedly connects the hydraulic means 24 and pallet fork 19. This extender means is also visible in FIG. 8. Preferably, each pallet jack has at least two pallet forks 19 and at least two corresponding extender means 18. This extender means 18 is a necessary feature of the improved pallet jack 28, and a feature that results in cargo transport at an angle. The extender means 18 is preferably a formed of metal or metal alloy unit that hingedly connects hydraulic means 24 of the pallet jack 28 to jack forks 19 of the pallet jack 28 which jack forks 19 reach under a pallet to grab and secure a load of cargo. Jack forks 19 preferably reach under a pallet by means of push rod actuators, or equivalent means, within the forks that move and extend therefrom. The extender means 18 is shaped in a manner so that downward action by the hydraulic means 24 of the pallet jack 28 causes the pallet fork(s) to move down and to extend outward. The extender means 18 preferably features a doglegged shape as shown in FIG. 9, which shape causes such extension of pallet forks 19 to occur at an acute angle relative to the ground. This outward, angled action typically occurs after the user of the pallet jack 28 inserts the pallet forks 19 under the pallet of product. As the pallet jack 28 operates, the cargo will be lifted up, typically in the range of 1 to 12 inches above the ground, and leaned back against the backstop 26 of the pallet jack 28.

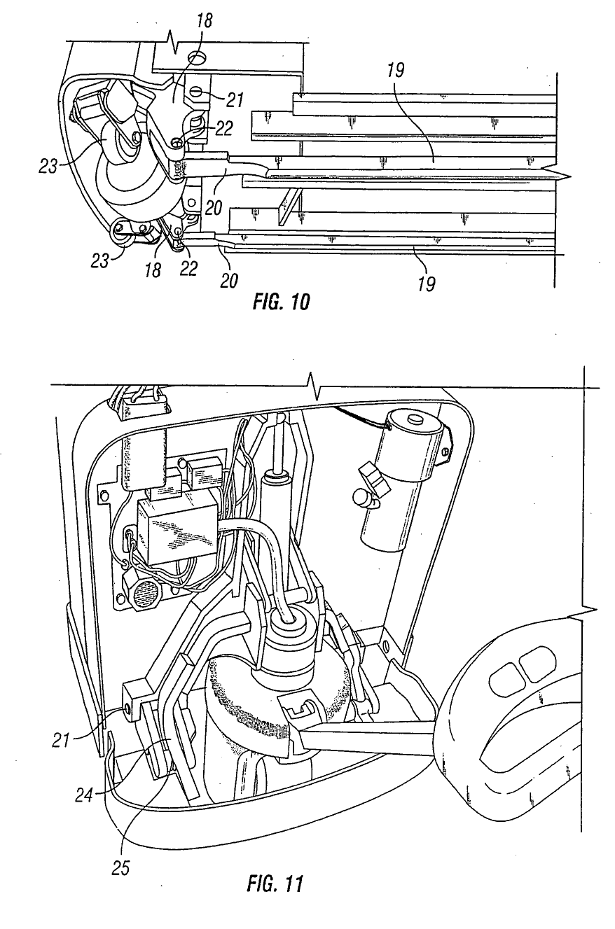

FIG. 10 and FIG. 11 are discussed simultaneously given that both figures demonstrate features of the improved pallet jack 28. FIG. 10 is an underside perspective view of the improved pallet jack 28 that shows a more detailed and three-dimensional rendition of how pallet jack 28 components interconnect. FIG. 11 is a rear cut-away perspective view showing how the hydraulic system of a pallet jack connects to and operates with the components of the present invention. In FIG. 10, the extender means 18 is shown as it is hingedly connected to a frame 27 of pallet jack 28 at a first axis 21. The extender means 18 rotates on first axis 21 when a hydraulic means 24 presses down on the extender means 18 at top axis 25, further shown in FIG. 11. The extender means 18 redirects downward force of the hydraulic means 24 (FIG. 11), so that extender means 18 swings around the first axis 21 and applies a downward and forward directed force to jack fork(s) 19. Jack fork(s) 19 are hingedly connected to the extender means 18 at a third axis 22 found at the lower portion of extender means 18. The preferable three-dimensional shape of extender means 18 is visible in FIGS. 10 and 11, along with the three preferable axis points, namely the first axis 21, second axis 25, and third axis 22. Also shown in FIG. 10 are indentions 20 along the base of jack forks 19 at the point where the jack forks 19 meet the extender means 18. Such indentions 20 are adapted to maximize ground clearance of the jack forks 19 when they are engaged. Because of the down and forward action of the extender means 18, the jack forks 19 are closely disposed to the ground and preferably benefit from additional clearance afforded by indentions 20. Also visible in FIG. 10 are stabilizer means 23, present on each side and fixedly mounted at the underside base of the pallet jack 28. In FIG. 11, the stabilizer means are preferably wheel and caster units that are particularly desirable on a pallet jack 28 that had been modified to carry a rear leaning load of products. The industry standard pallet jacks typically will have a single wheel in the rear that is well adapted for maneuverability, however, which failed to adequately support the loads contemplated by the system of the present invention.

The present invention has been illustrated in great detail by the above referenced examples, however, it is to be understood that such examples are illustrative and that this invention is not limited by any of the details in the illustrations. Those skilled in the art will understand the present invention is capable of many variations without deviating from the scope of the invention. Accordingly, the claims are to be construed broadly within the scope of the invention.

We claim:

1. A pallet cap comprising:
(a) a top surface and a plurality of side surfaces fixed to said top surface, said side surfaces extending downward therefrom; and,
(b) a plurality of nodules disposed in spaced relation on said top surface, and whereby a plurality of channels are formed between said plurality of nodules.

2. The pallet cap of claim 1 wherein said plurality of nodules are formed of a shape selected from the group consisting of square nodules, polygonal nodules, and round nodules.

3. The pallet cap of claim 1 wherein said plurality of nodules comprising polygonal nodules are disposed around a periphery of said top surface.

4. The pallet cap of claim 1 wherein said plurality of nodules comprising round nodules are disposed at corners of said top surface.

5. The pallet cap of claim 1, further comprising a jack fork receiving area formed in at least two of said plurality of side surfaces, said jack fork receiving area suitable for allowing a jack fork of a pallet jack to pass therethrough.

6. The pallet cap of claim 1, said top surface having length of approximately 30 to 60 inches and a width of approximately 25 to 50 inches.

7. The pallet cap of claim 1, said plurality of nodules extending upwardly above said top surface for a distance of approximately ½ to 5 inches.

8. The pallet cap of claim 1 each of said plurality of nodules having a top with a surface area in the range of ¼ to 36 square inches.

9. A pallet comprising:
(a) a frame having a top surface and a bottom surface with sides extending therebetween;
(b) said top surface having a plurality of nodules extending upwardly therefrom and a plurality of nodules defining a plurality of channels between said plurality of nodules,
(c) said frame having a fork receiving area formed through at least one of said sides, said fork receiving areas suitable for allowing a fork of a forklift to pass therethrough.

10. The pallet of claim 9 wherein said plurality of nodules are formed of a shape selected from the group consisting of square nodules, polygonal nodules, and round nodules.

11. The pallet of claim 9, said plurality of nodules comprising polygonal nodules disposed around a periphery of said top surface.

12. The pallet of clam 9, said plurality of nodules further comprising round nodules disposed at corners of said top surface.

13. A forked dolly for use with a pallet having channels formed on a top surface thereof, the dolly comprising:
(a) a frame having at least two wheel units fixed to a base of said frame;
(b) a nose plate disposed at said base of said frame, said nose plate having a plurality of tines extending therefrom.

14. A pallet system comprising:
(a) a dolly frame with at least two wheel units fixed to a base of said dolly frame, said dolly frame having a nose plate also disposed at said base;
(b) said nose plate featuring a plurality of tines;
(c) a pallet cap suitable for placement over a pallet, said pallet cap having a plurality of channels formed in a top surface thereof between a plurality of nodules;
(d) said tines slidably insertable into said plurality of channels formed between a plurality of nodules.

15. A stabilized pallet jack comprising:
(a) a frame;
(b) at least one extender connected hingedly to said frame on a first axis;
(c) a hydraulic means for acting on the extender at a second axis;
(d) said extender connecting hingedly at a third axis to at least one jack fork;
(e) said hydraulic means for imparting a downward action on said extender to cause the extender to swing on said first axis and said third axis, whereby the jack forks extend forward.

16. The stabilized pallet jack of claim 15 wherein the jack fork has an indention occurring at an end hingedly connected to said third axis, and whereby such indention assists with ground clearance as said jack forks are thrust down and forward to lift cargo at a back leaning angle.

17. The stabilized pallet jack of claim 15, further comprising a backstop fixedly connected to said frame.

18. The stabilized pallet jack of claim 15, further comprising a plurality of stabilizer means fixedly connected to opposite sides of a base of said frame, said stabilizer means for adding additional lateral and rear support to the pallet jack which holds back leaning loads at an angle.

19. The stabilized pallet jack of claim 15, wherein said hydraulic means acts on the extender so as to carry raised loads at an angle in the range of 1 to 30 degrees relative to horizontal.

20. A pallet transport system comprising:
(a) a pallet structure having a plurality of upwardly extending nodules on a top surface thereof;
(b) a dolly with a noseplate having a plurality of tines, said tines adapted to fit into channels formed between said plurality of nodules; and,
(c) a stabilized pallet loader with jack forks that are adapted to removably engage said pallet at jack fork receiving areas formed in said pallet structures, whereby the entire pallet, pallet cap and cargo are situated on said jack forks at a backward leaning angle.

21. The pallet transport system of claim 20, said pallet structure comprising:
(a) a pallet cap having said plurality of upwardly extending nodules formed thereon;
(b) a pallet having a top surface and a bottom surface at sides extending therebetween, said pallet cap positioned over said top surface of said pallet and extending downwardly over said side of said pallet.

22. The pallet transport system of claim 20, said dolly comprising a frame having a handle and a base; said jack having at least two wheels rotatably connected to said base; and a nose plate disposed at said base of said frame, said nose plate having said plurality of tines extending therefrom.

23. The pallet transport system of claim 20, said pallet jack comprising a jack frame; at least one extender hingedly connected to said jack frame on at least one fixed axis; a hydraulic means affixed to said jack frame, said hydraulic means for acting on the extender so as to pivot the extender between a first position and a second position, said extender being hingedly connected at another axis to the jack fork; the jack fork extending forwardly as said extender pivots from said first position to said second position.

24. A method of loading and unloading comprising:
(a) placing a pallet cap over a pallet, said pallet cap having a plurality of nodules extending upwardly from a top surface thereof so as to define channels therebetween;
(b) loading cases of beverages on said top surface of the pallet cap where the cases are stacked in even vertical columns;
(c) inserting the tines of a forked dolly in said channels; and,
(d) leaning said forked dolly backwards to remove at least one case of said cases of beverages.

25. A method of loading and unloading a pallet comprising:
(a) placing a pallet cap over a pallet, said pallet cap having a plurality of nodules extending upwardly from a top surface thereof so as to define channels therebetween;
(b) loading cases of beverages on said top surface of the pallet cap where the cases are stacked in even vertical columns;
(c) using a stabilized pallet jack to pick up and transport the loaded pallet;
(d) wrapping the loaded pallet with a stabilizing wrap;
(e) transporting the loaded pallet to a location;
(f) removing stabilizing wrap from said loaded pallet subsequent to said step of transporting;
(g) inserting the tines of a forked dolly in said channels; and,
(h) leaning said forked dolly backwards to remove at least one case of said cases of beverage.
